(19) United States
(12) Patent Application Publication
(10) Pub. No.: US 2015/0301700 A1
(43) Pub. Date: Oct. 22, 2015

(54) PORTABLE ELECTRONIC EQUIPMENT AND CONTROL PROGRAM THEREOF

(71) Applicant: SHARP KABUSHIKI KAISHA, Osaka-shi Osaka (JP)

(72) Inventor: Kohji KOMORI, Osaka-shi (JP)

(73) Assignee: SHARP KABUSHIKI KAISHA, Osaka-shi Osaka (JP)

(21) Appl. No.: 14/646,400

(22) PCT Filed: Feb. 17, 2014
(86) PCT No.: PCT/JP2014/053608

§ 371 Date: May 21, 2015

(30) Foreign Application Priority Data
Mar. 8, 2013 (JP) 2013-046853

(51) Int. Cl. G06F 3/0482; G06F 3/0484

(52) U.S. Cl. CPC G06F 3/0482; G06F 3/04842

(57) ABSTRACT

In a portable electronic equipment, a storage unit stores a plurality of installed application software. A display unit can display an indicator individually associated with each application software. When a user uses an operation unit to perform an operation of selecting the indicator, the selected application software is started. An interface unit can connect a plurality of external equipments. A control unit is configured to, when an external equipment is connected to the interface unit, change an indicator displayed on the display or modify an arrangement of the indicator in accordance with a kind of the connected external equipment.

### TECHNICAL FIELD

This invention relates to a portable electronic equipment and a control program thereof, which are suitably used for a portable communication terminal such as a smart phone or a feature phone, for example.

### BACKGROUND ART

On a display unit of a portable electronic equipment such as a smart phone, a shortcut icon or a widget (hereinafter, sometimes collectively referred to as “indicator”) for starting application software is typically displayed. When a large number of application software are installed in the portable electronic equipment, a large number of shortcut icons and widgets are displayed on a plurality of screens. Therefore, a user takes a long time to find on the screens a shortcut icon or a widget representing an application which the user would like to start.

As a technology related to the problem described above, there has been a known technology disclosed in, for example, Japanese Patent Laying-Open No. 2012-003487 (PTD 1). The information processing apparatus of this document records its own position at the time of instructing a startup of an application program. In a vicinity of a position where one application program has been instructed to start for the certain number of times or more, a shortcut for starting up the application program is set.

### CITATION LIST

### Patent Document

PTD 1: Japanese Patent Laying-Open No. 2012-003487

### SUMMARY OF INVENTION

### Technical Problem

When an external equipment such as a headphone or a microphone is connected, it is considered to be highly possible that application software using the connected external equipment is to be used. However, the conventional art has no description focusing on a relevance between displaying of a shortcut or widget and the external equipment.

A main object of the present invention is to provide a portable electronic equipment capable of readily using application software which is highly relevant to a connected external equipment.

### Solution to Problem

A portable electronic equipment according to one embodiment includes a storage unit, a display unit, an operation unit, an interface unit, and a control unit for controlling the display unit. The storage unit stores a plurality of installed application software. The display unit is capable of displaying an indicator individually associated with each application software. A user performs an operation of selecting the indicator with use of the operation unit to start the selected application software. The interface unit can connect a plurality of external equipments. The control unit is configured to, when an external equipment is connected to the interface unit, modify the indicator displayed on the display unit or modify an arrangement of the indicator in accordance with a kind of the connected external equipment.

### Advantageous Effects of Invention

According to the embodiment described above, application software which is highly relevant to a connected external equipment can be readily used.

### BRIEF DESCRIPTION OF DRAWINGS

FIG. 1 represents one example of an appearance of a portable electronic equipment according to the first embodiment.

FIG. 2 is a block diagram representing a hardware configuration of the portable electronic equipment of FIG. 1.

FIG. 3 is a block diagram representing functions of the portable electronic equipment of FIG. 2.

FIG. 4 represents one example of a table stored in the table storage unit of FIG. 3.

FIG. 5 represents one example of a set value of a display form stored in the display setting storage unit of FIG. 3.

FIG. 6 is a flowchart representing procedures of modifying a display screen when the external equipment is connected to the portable electronic equipment.

FIG. 7 represents one example of a display screen which is provided when the external equipment is connected to the portable electronic equipment of FIG. 1.

FIG. 8 represents an enlarged illustration of an icon 20 of FIG. 7.

FIG. 9 represents another example of a display screen which is provided when the external equipment is connected to the portable electronic equipment of FIG. 1.

FIG. 10 represents yet another example of a display screen which is provided when the external equipment is connected to the portable electronic equipment of FIG. 1.

FIG. 11 represents one example of an appearance of the portable electronic equipment according to the second embodiment.

FIG. 12 represents one example of a display screen which is provided when the external equipment is connected to the portable electronic equipment of FIG. 11.

### DESCRIPTION OF EMBODIMENTS

In the following, embodiments will be described in detail with reference to the drawings. It should be noted that the same reference numerals are allotted to the same or corresponding parts, and description thereof will not be repeated.

### First Embodiment

### Overall Configuration of Portable Electronic Equipment

FIG. 1 represents one example of an appearance of a portable electronic equipment 1 according to the first embodiment. In the first embodiment, the case about a smart phone will be described as one example of portable electronic equipment 1.

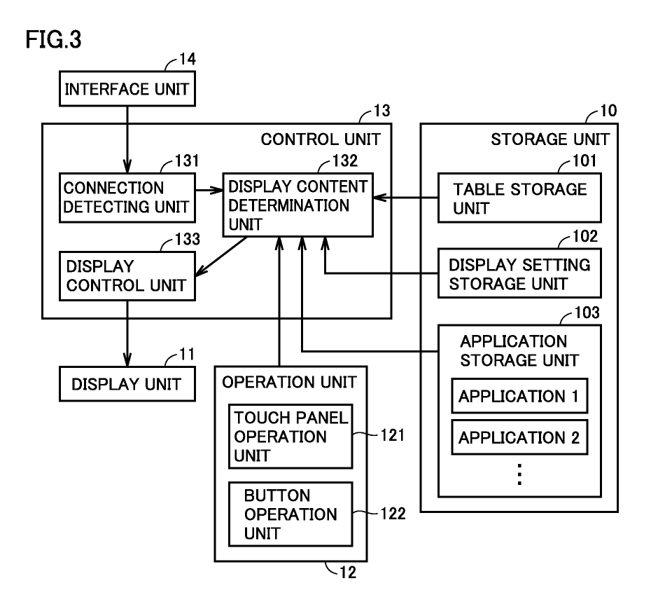

Referring to FIG. 1, portable electronic equipment 1 has a plate-like housing 2, and a display unit 11 is provided on a front face of housing 2. A touch panel operation unit 121 is provided which is integral with this display unit 11. A user can perform an input operation by touching touch panel 121. Further, an LED (Light Emitting Diode) 5 is provided on an upper part of the front face of housing 2, and an earphone jack (not illustrated) for inserting a plug of headphone 61 is provided on an upper face of housing 2. Portable electronic equipment 1 is further provided with a loudspeaker, an antenna, a button operation unit (reference numeral 122 in FIG. 3), and the like, which are not illustrated in the drawing. Button operation unit 122 includes, for example, a home button, a volume button, and the like.

In the example shown in FIG. 1, a standby screen (also referred to as a home screen) of a smart phone is displayed on display unit 11. The standby screen includes shortcut icons A to H (widgets may be provided in place of shortcuts) associated respectively with application software. By touching the touch panel at a location where a shortcut icon is displayed, a user can start the application software associated with the shortcut icon arranged at the touched location.

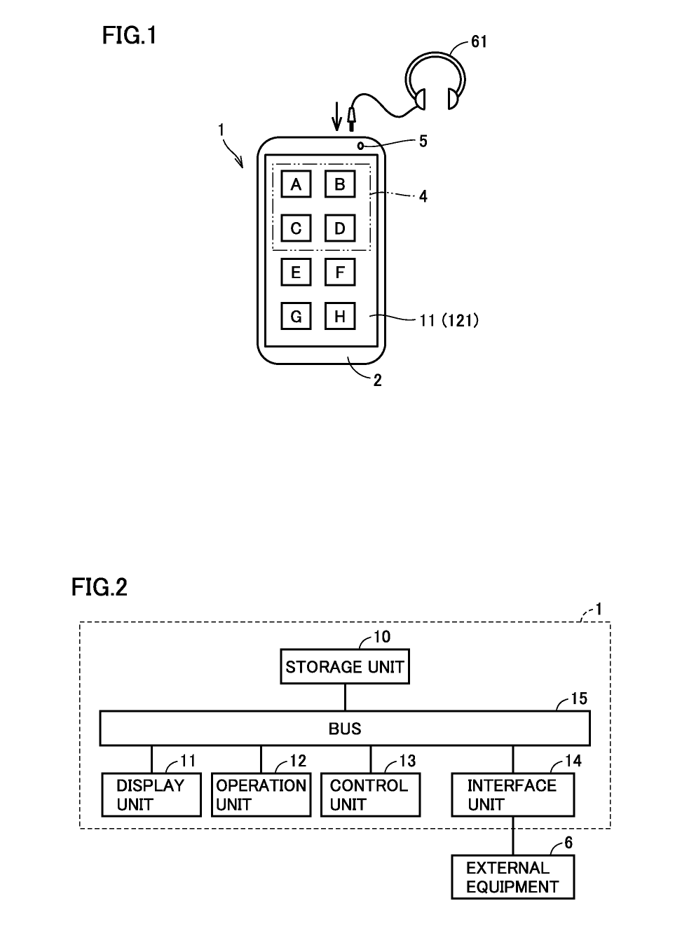

As will be described later in detail, in portable electronic equipment 1 according to the first embodiment, a display content in a specific region 4 of display unit 11 is modified when an external equipment (reference numeral 6 in FIG. 2) such as a headphone 61 is connected to portable electronic equipment 1. Specifically, a shortcut icon associated with application software which uses connected external equipment 6 is automatically generated in this specific region 4. A position of specific region 4 and the number of shortcut icons displayed in specific region 4 can be set by a user (these set values are stored in a display setting storage unit 102 of FIG. 3).

FIG. 2 is a block diagram representing a hardware configuration of portable electronic equipment of FIG. 1. Referring to FIG. 2, portable electronic equipment 1 includes a storage unit 10, display unit 11, an operation unit 12, a control unit 13, an interface unit 14, and a bus 15 connecting these elements.

Storage unit 10 includes a non-volatile memory such as a flash memory, and stores a program and data. A detailed function of storage unit 10 will be described with reference to a functional block diagram of FIG. 3.

Display unit 11 displays a standby screen or a screen associated with the application software. For example, a liquid crystal display or an organic EL (Electro-Luminescence) display is used as display unit 11.

Operation unit 12 includes a touch panel operation unit 121 and a button operation unit 122 as shown in FIG. 3. A user uses operation unit 12 to perform an operation of selecting a shortcut icon displayed on display unit 11. Application software associated with the selected shortcut icon is started.

Control unit 13 is, for example, a microprocessor, and it operates in accordance with a control program to control an overall operation of portable electronic equipment 1. A detailed function of control unit 13 will be described later with reference to a functional block diagram of FIG. 3.

Interface unit 14 is a part which serves as an intermediate portion for sending/receiving a signal to and from external equipment 6, and it converts a format of a signal and/or converts a signal level. Interface unit 14 is provided with a connector associated with external equipment 6. Other than headphone 61 shown in FIG. 1, external equipment 6 such as a charger and a keyboard can be connected to interface unit 14 of FIG. 2.

Portable electronic equipment 1 is further provided with, for example, a communication device for performing a voice communication and a data communication. However, since the communication device is not directly related to a user interface control at the time of connection with external equipment 6, it is not illustrated in FIG. 2.

### Functional Configuration of Portable Electronic Equipment

FIG. 3 is a block diagram representing functions of portable electronic equipment 1 of FIG. 2. In the following, functions of storage unit 10 and control unit 13 will be described in detail with reference to FIG. 3.

### 1. Storage Unit

Storage unit 10 includes a table storage unit 101, a display setting storage unit 102, and an application storage unit 103.

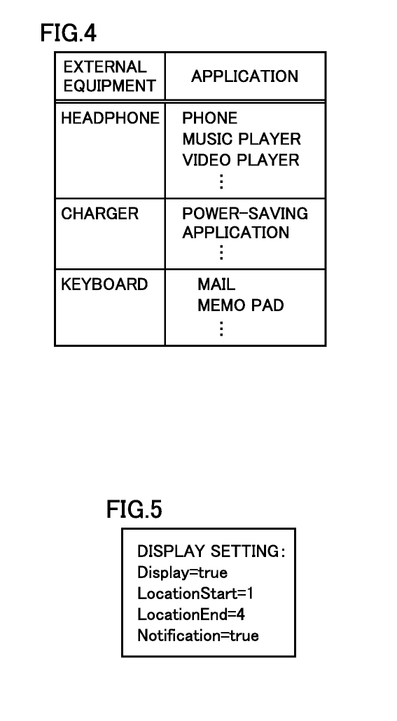

FIG. 4 represents one example of a table stored in table storage unit 101 of FIG. 3. Referring to FIGS. 3 and 4, table storage unit 101 stores a correspondence between a plurality of external equipment 6 being connectable to interface unit 14 and application software which are operable when each external equipment 6 is connected.

Table storage unit 101 stores data representing associated with application software (names, registration numbers, or the like) together with priorities of each software (in the table shown in FIG. 4, the arrangement of application software correspond to the priorities). As will be described later, when one external equipment 6 is connected to the interface unit, a shortcut icon for software with a higher priority among associated installed application software is displayed preferentially (for example, near the upper part of display unit 11).

Specifically in the example of FIG. 4, a phone, a music player, and a video player as the application software associated with headphone 61 are registered in the arrangement of priorities. A power-saving application and the like are registered as application software associated with the charger. A mail and a memo pad are registered as application software associated with the keyboard.

FIG. 5 represents one example of a set value of a display form stored in display setting storage unit 102 of FIG. 3. Referring to FIGS. 3 and 5, display setting storage unit 102 stores a set value related to a display form of display unit 11 when external equipment 6 is connected.

Specifically in the example of FIG. 5, the parameter “Display” is used for setting whether or not the display on the display unit is modified when external equipment 6 is connected. The parameters “LocationStart” and “LocationEnd” are used for setting the arrangement positions and the number of arranged shortcut icons representing application software associated with connected external equipment 6. For example, in the case where LocationStart=1 and LocationEnd=4 are provided, associated shortcut icons and/or widgets are arranged at the first to fourth arrangement positions (four locations in total) on display unit 11. The parameter “Notification” is used for setting whether or not to notify a user of the modification of the display of display unit 11 by means of light, sound, or image (icon) when external equipment 6 is connected.

Referring again to FIG. 3, application storage unit 103 stores installed application software.

### 2. Control Unit

Control unit 13 has functions of a connection detecting unit 131, a display content determination unit 132, and a display control unit 133. These functions are achieved when the control program stored in storage unit 10 is executed by the microprocessor as control unit 13. Control unit 13, as a matter of course, includes other functional block such as a communication control unit and the like. However, elements which are not directly related to the user interface control at the time of connection of external equipment 6 are not illustrated in FIG. 3.

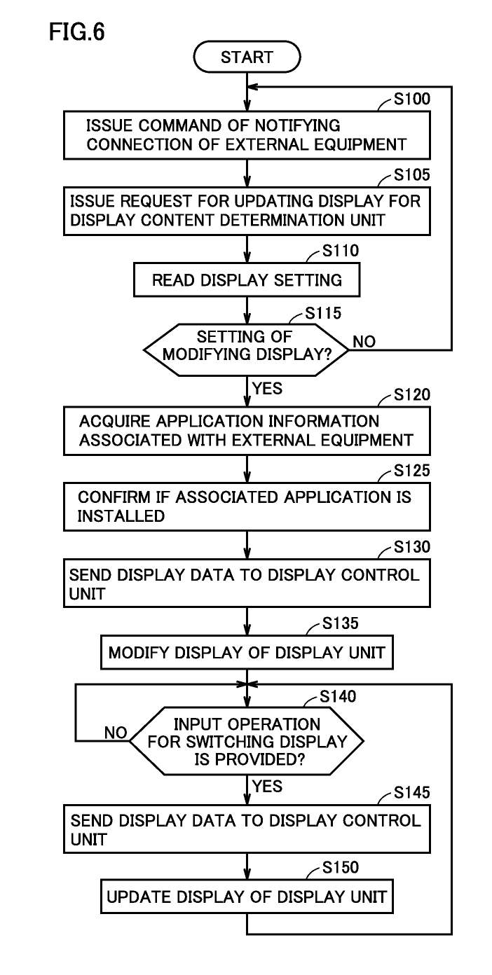

Connection detecting unit 131 detects whether or not external equipment 6 is connected to interface unit 14. Display content determination unit 132 determines a content to be displayed on display unit 11 based on information stored in table storage unit 101, display setting storage unit 102, and application storage unit 103 when the connection of external equipment 6 is detected. Display control unit 133 controls display unit 11 so that the display content determined by display content determination unit 132 is displayed. In the following, operations of the functional blocks at the time of connection of external equipment 6 will be described with reference to the flowchart of FIG. 6.

FIG. 6 is a flowchart representing the procedures of modifying the display screen when external equipment 6 is connected to portable electronic equipment 1.

Referring to FIGS. 3 and 6, when external equipment 6 is connected to portable electronic equipment 1, interface unit 14 issues for connection detecting unit 131 a command of notifying the connection of external equipment 6 (Step S100). When the command is received, connection detecting unit 131 issues for display content determination unit 132 a request for updating the displayed content of display unit 11 (Step S105).

When the request for updating the display content is received from connection detecting unit 131, display content determination unit 132 reads a display setting stored in display setting storage unit 102 (Step S110). Then, when the setting of modifying the screen display of display unit 11 at the time of connection of external equipment 6 is provided (YES in Step S115), display content determination unit 132 acquires from table storage unit 101 the information of the application software associated with connected external equipment 6 (Step S120). Further, display content determination unit 132 refers to application storage unit 103 to confirm whether or not the associated application software acquired from table storage unit 101 has already been installed (Step S125).

Based on the information described above, display content determination unit 132 determines a shortcut icon, representing the installed application software associated with connected external equipment 6, as display data to be displayed in specific region 4 of display unit 11 of FIG. 1. Display content determination unit 132 sends the determined display data to display control unit 133 (Step S130). Based on the display data received from display content determination unit 132, display control unit 133 displays in specific region 4 of display unit 11 a shortcut icon for starting the associated application software. Consequently, the display image of display unit 11 is modified (Step S135).

When there are a large number of application software associated with connected external equipment 6, shortcut icons associated with these application software are displayed in the arrangement of priorities using a plurality of screens. In this case, when an input operation for switching display screens is received through operation unit 12 (Step S140), display content determination unit 132 sends data of the shortcut icon to be newly displayed in specific region 4 of display unit 11 to display control unit 133 (Step S145). Based on the display data received from display content determination unit 132, display control unit 133 updates the display content in specific region 4 of display unit 11 (Step S150).

It should be noted that, although the specific procedures are not illustrated in FIG. 6, when the application software to be executed is selected by a user touching touch panel 121, a screen associated with the selected application software is displayed on display unit 11. When external equipment 6 is detached, the display of display unit 11 returns to the initial standby screen.

### Example of Display Screen Which is Provided When External Equipment is Connected

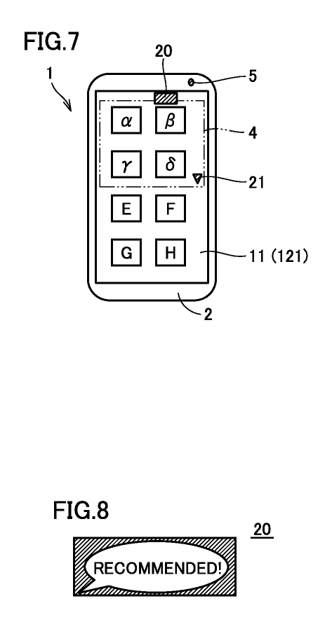

FIG. 7 represents one example of the display screen which is provided when external equipment 6 is connected to portable electronic equipment of FIG. 1. FIG. 7 represents a display screen for the case where headphone 61 is connected as external equipment 6.

As shown in FIG. 7, in specific region 4 where shortcut icons A to D are shown in FIG. 1, shortcut icons α to δ (α: phone, β: music player, γ: video player) associated with the headphone shown in the table of FIG. 5 are generated. The arrangement of shortcut icons α to δ in specific region 4 follows the priorities stored in table storage unit 101 of FIG. 3.

Control unit 13 may notify a user that the short icons to be displayed in specific region 4 are modified. For example, the notification may be made by emission of light from LED 5 or by means of sound. Alternatively, control unit 13 may display in an upper part of display unit 11 an icon 20 for notification to a user. FIG. 8 is an enlarged view of icon 20 of FIG. 7.

When there are five or more application software associated with headphone 61, not all of the shortcut icons for starting the associated application software can be displayed in specific region 4 of FIG. 1. In this case, an indicator 21 for switching display screens is displayed on display unit 11. A user can switch to the next screen by touching a location where indicator 21 is displayed.

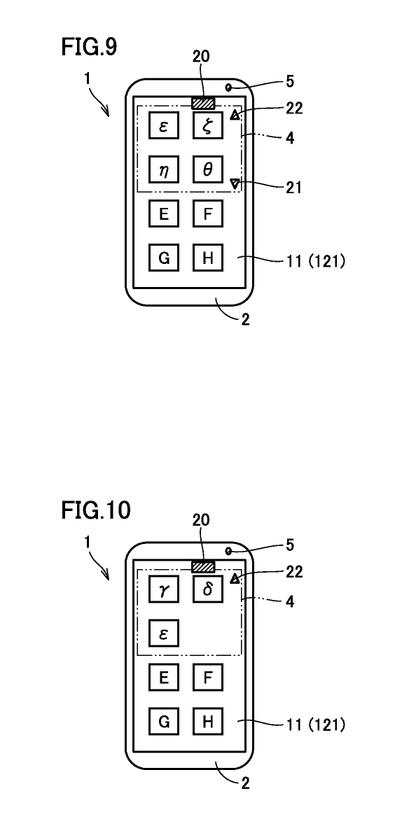

FIG. 9 represents another example of the display screen which is provided when external equipment 6 is connected to portable electronic equipment 1 of FIG. 1. The display screen of FIG. 9 represents the case where the location of indicator 21 on the display screen of FIG. 7 is touched. It is assumed that there are nine or more application software associated with external equipment 6 being currently connected.

As shown in FIG. 9, shortcut icons α to δ having been displayed in FIG. 7 are deleted, and shortcuts ε to θ associated with the application software of next priorities are displayed in specific region 4. In FIG. 9, when a user touches a location where an indicator 22 oriented upward is displayed, the display screen returns to the screen shown in FIG. 7. When a user touches a location where an indicator 21 oriented downward is displayed, the display screen is switched to the next screen.

FIG. 10 represents yet another example of the display screen which is provided when the external equipment is connected to the portable electronic equipment of FIG. 1. The display screen of FIG. 10 represents the case where the location of the display screen of FIG. 7 displaying indicator 21 is touched, similarly to the case of FIG. 9. However, it is assumed that there are five application software associated with external equipment 6 which is currently connected.

As shown in FIG. 10, shortcut icons α and β having been displayed in FIG. 7 are deleted, and shortcut icons γ and δ are displayed while display positions thereof are shifted upward as compared to the case of FIG. 7. A shortcut icons associated with the application software of the next priority is newly displayed. When a user touches the location where indicator 22 is displayed, the display screen returns to the screen shown in FIG. 7.

### Effects

As described above, according to portable electronic equipment 1 of the first embodiment, shortcuts or widgets for starting the application software related to connected external equipment 6 are preferentially displayed in specific region 4 of display unit 11. Accordingly, application software which is highly relevant to connected external equipment 6 can be readily used.

### Second Embodiment

In a portable electronic equipment 1A according to the second embodiment, the display form of shortcut icons and/or widgets is different from that of the case of the first embodiment. Other points, such as the hardware configuration shown in FIG. 2, the functional block diagram shown in FIG. 3, and the flowchart of the procedures of modifying the display shown in FIG. 6 are the same in the first and second embodiments. In the following description, there is a case where the parts which are the same as or corresponding to portable electronic equipment 1 according to the first embodiment are allotted with the same reference numerals, and description thereof is not repeated.

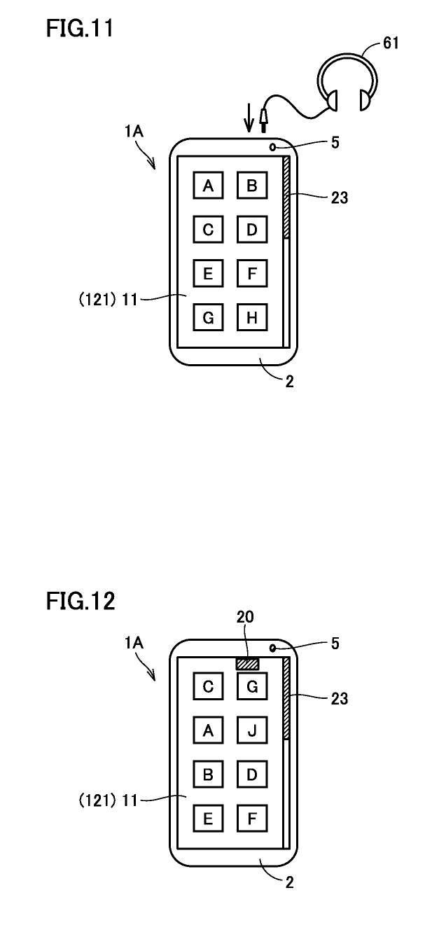

FIG. 11 represents one example of an appearance of portable electronic equipment 1A according to the second embodiment. Referring to FIG. 11, shortcut icons A to H are shown on display unit 11 of portable electronic equipment 1A. Further, a scroll bar 23 is displayed on a right side portion of display unit 11. In the case where there are 9 or more applications installed in the portable electronic equipment, shortcut icons or widgets not shown in FIG. 11 can be displayed by scrolling scroll bar 23. It would not be necessary to display the scroll bar when there are eight or less installed applications.

FIG. 12 represents one example of the display screen which is provided when external equipment 6 is connected to the portable electronic equipment of FIG. 11. When headphone 61 as external equipment 6 is connected in FIG. 11, the display screen of display unit 11 is changed to the screen as shown in FIG. 12.

Specifically in the example of FIG. 12, the arrangement of shortcut icons A to H are modified so that shortcut icons C, G, A, and J (C: phone, G: music player, A: video player) for starting the application software associated with headphone 61 are preferentially displayed in the upper part of display unit 11. The arrangement of alignment of shortcut icons C, G, A, and J associated with headphone 61 follows the priority of the corresponding application software stored in table storage unit 101 of FIG. 3.

Similarly to the case of the first embodiment, control unit 13 may notify the user by means of LED 5 and/or icon 20 that the display screen of display unit 11 has been modified.

### Modified Example

Also in the feature phone in place of the smart phone, the display screen can be modified in accordance with the connected external equipment, similarly to the first and second embodiments described above.

For example, in the case of the feature phone, a menu screen for selection of the application software is displayed on display unit 11. In this case, character strings representing each application software are displayed on the menu screen as indicators associated with shortcuts or widgets. By using button operation unit 122 of FIG. 3, a user can start up the application software represented by the selected string as the indicator. When external equipment 6 is connected, the arrangement of the character strings as the indicators are modified so that character strings (indicators) representing the application software associated with connected external equipment 6 are displayed in the upper part of the menu screen.

It should be understood that the embodiments and examples disclosed herein are illustrative and non-restrictive in every respect. The scope of the present invention is defined by the terms of claims, and is intended to include any modifications within the scope and meaning equivalent to the terms of the claims.

### REFERENCE SIGNS LIST

1, 1A portable electronic equipment; 4 specific region; 6 external equipment; 10 storage unit; 11 display; 12 operation unit; 13 control unit; 14 interface unit; 61 headphone; 101 table storage unit; 102 display setting storage unit; 103 application storage unit; 121 touch panel operation unit; 122 button operation unit; 131 connection detecting unit; 132 display content determination unit; 133 display control unit.

1. A portable electronic equipment, comprising:
a storage unit for storing a plurality of installed application software;
a display unit capable of displaying an indicator individually associated with each of said application software;
an operation unit, operated by a user to select said indicator, for starting selected application software;
an interface unit capable of connecting a plurality external equipments; and
a control unit for controlling said display unit,
said control unit being configured to, when an external equipment is connected to said interface unit, perform a display screen modification of modifying said indicator displayed on said display unit or modifying an arrangement of said indicators in accordance with a kind of said connected external equipment.

2. The portable electronic equipment according to claim 1, wherein
for each of said plurality of external equipments, said storage unit further stores a correspondence with one or a plurality of application software which can be operated with use of each of said external equipment, and
when an external equipment is connected to said interface unit, said control unit specifies installed application software associated with the connected external equipment based on said correspondence stored in said storage unit and performs said display screen modification based on the specified result.

3. The portable electronic equipment according to claim 2, wherein
said display unit displays said indicator as an icon, and
said control unit displays on a specific region of said display unit said indicator for starting said installed application software corresponding to the connected external equipment in said display screen modification.

4. The portable electronic equipment according to claim 2, wherein
said control unit modifies an arrangement of said indicator in said display screen modification so that said indicator for starting said installed application corresponding to said connected external equipment is preferentially displayed in an upper part of said display.

5. A non-transitory computer-readable medium storing a control program of a portable electronic equipment,
said portable electronic equipment comprising:
a storage unit for storing a plurality of installed application software;
a display unit capable of displaying an indicator individually associated with each of said application software;
an operation unit, operated by a user to select said indicator, for starting selected application software;
an interface unit capable of connecting a plurality of external equipments; and
a control unit for controlling said display unit,
said control program allowing said control unit to execute the steps of:
detecting that an external equipment is connected to said interface unit; and
performing a display screen modification of modifying said indicator displayed on said display or modifying an arrangement of said indicators in accordance with a kind of said connected external equipment.
